(19) United States
(12) Patent Application Publication
(10) Pub. No.: US 2012/0092118 A1
(43) Pub. Date: Apr. 19, 2012

(54) HOLDER FOR HIGH-VOLTAGE END LEADS IN OIL TRANSFORMERS

(75) Inventor: Hartmut BRENDEL, Halle (DE)

(73) Assignee: ABB Technology AG, Zurich (CH)

(21) Appl. No.: 13/272,727

(22) Filed: Oct. 13, 2011

(30) Foreign Application Priority Data
Oct. 15, 2010 (EP) 10187708.2

(51) Int. Cl. H01F 27/29

(52) U.S. Cl. 336/192

(57) ABSTRACT

A holder is provided for high-voltage end leads in oil transformers. The holder includes a plate-like, elongated basic insulation module which has two planar outer sides and a connecting device at its first end and an accommodating device for a transversely running a screen tube in the region of its second end. The basic insulation module is angled between the first end and the second end, such that a shorter side edge and an opposite longer side edge is formed. A plurality of adjacent slots are provided transversely to the elongated extent of the basic insulation module, where the slots encircle the latter at its planar outer sides and at the shorter side edge in a respective plane. At least one U-shaped insulation plate is fitted into one of the slots in a positive-locking manner.

### RELATED APPLICATION

This application claims priority under 35 U.S.C. §119 to European Patent Application No. 10187708.2 filed in Europe on Oct. 15, 2010, the entire content of which is hereby incorporated by reference in its entirety.

### FIELD

The present disclosure relates to a holder for high-voltage end leads in oil transformers.

### BACKGROUND INFORMATION

It is generally known that transformers having a rated output of, for example, 100 MVA and above at a rated voltage of 110 kV and above are normally embodied as oil transformers, which can have a weight of 200 t. In this case, the transformer is arranged inside an oil-filled transformer tank, the oil serving for both the insulation and improved cooling. Here, the respective terminals of the transformer are electrically connected to the lead-out insulators on the outer side of the oil tank by electrical conductors which, at high voltages, are surrounded by an insulated screen tube which is at the same potential, and the insulation of which is formed either by solid insulating materials or by a barrier system. The barrier system is in this case constructed radially symmetrically around the relevant conductor and includes an electrically conductive screen tube with, if need be, a plurality of spaced-apart insulation barriers. The barrier systems required for each individual conductor are directed inside the oil-filled transformer tank through a space formed between the transformer and tank wall, although minimum distances required from the insulation point of view have to be maintained.

For reasons of mechanical stability and short-circuit strength, the insulated screen tubes are to be supported or held at certain distances, that is to say they are to be connected mechanically either to the outer wall of the tank or to a suitable region of the transformer. Used for this purpose are “holders” which are to be embodied as insulators and are produced, for example, from a pressboard. The insulating ability of a holder as such is less than the insulating ability of pure oil at an identical insulating clearance.

A disadvantage, however, is that transformers of this size are one-off items or are at least produced only in small production runs, thereby resulting in different requirements for the configuration of a respective holder for each transformer geometry. The requirements with respect to a holder vary even within a plurality of holders for one and the same transformer type because other potential conditions arise during the operation of the transformer for each attachment location of a holder in the transformer tank. This therefore results in a large diversity of variants in the configuration of the holders adapted to the respective potential conditions to be expected.

This diversity of variants can be reduced by the distance between the transformer and tank being correspondingly increased, as a result of which holders that are not optimally adapted to the respective potential conditions can also be used. However, this has the disadvantage that the transformer together with its oil tank has to be designed to be larger than is absolutely necessary.

### SUMMARY

An exemplary embodiment of the present disclosure provides a holder for high-voltage end leads in oil transformers. The exemplary holder includes a plate-like, elongated basic insulation module which has two planar outer sides, a first end and a second end. The basic insulation module includes a connecting device at the first end and an accommodating device for a transversely running screen tube in a region of the second end. The basic insulation module is angled between the first end and the second end, such that a shorter side edge and an opposite longer side edge are formed. The basic insulation module includes a plurality of adjacent slots provided transversely to an elongated extent of the basic insulation module, where the slots encircle the basic insulation module at its planar outer sides and at the shorter side edge in a respective plane. The basic insulation module includes at least one U-shaped insulation plate fitted into one of the slots in a positive-locking manner.

### BRIEF DESCRIPTION OF THE DRAWINGS

Additional refinements, advantages and features of the present disclosure are described in more detail below with reference to exemplary embodiments illustrated in the drawings, in which:

FIG. 1 shows a side view of a holder with a screen tube according to an exemplary embodiment of the present disclosure; and

FIG. 2 shows a third U-shaped insulation plate on a basic insulation module according to an exemplary embodiment of the present disclosure.

The reference symbols used in the drawings, and their meanings, are listed in summary form in the list of reference numerals. In principle, identical parts are provided with the same reference symbols throughout the drawings.

### DETAILED DESCRIPTION

Exemplary embodiments of the present disclosure provide a holder for end leads in oil transformers which is especially flexible and space-saving.

Exemplary embodiments of the present disclosure provide a holder for high-voltage end leads. In accordance with an exemplary embodiment, the holder includes a plate-like, elongated basic insulation module which has two planar outer sides and which has a connecting device at its first end and an accommodating device for a transversely running screen tube in the region of its second end. The basic insulation module is angled between the first end and the second end, such that a shorter side edge and an opposite longer side edge is formed. A plurality of adjacent slots are provided transversely to the elongated extent of the basic insulation module, where the slots encircling the latter at its planar outer sides and at the shorter side edge in a respective plane. At least one U-shaped insulation plate is fitted into one of the slots in a positive-locking manner.

In accordance with an exemplary embodiment, the holder is individually provided with respective creepage-path-extending insulation plates transversely to the longitudinal extent of the holder in accordance with the boundary conditions of the potential to be insulated. This can be done for each holder in accordance with an individual assessment of the planned installation location, where an optimum in terms of insulation is not just achieved by as large a number of insulation plates as possible being used. On the contrary, this is achieved by the specific use of few insulation plates in positions determined beforehand.

In accordance with an exemplary embodiment, a slot in the basic insulation module encircles the latter on at least three sides of the cross section in one plane, for example, along the two planar outer sides and, as it were, as a connecting slot lying in between transversely across the shorter side edge. A matching U-shaped insulation plate, the thickness of which is accordingly just a little less than the thickness of the partly encircling slot, for example 3 mm, can easily be pushed from the shorter side edge onto the desired slot and fixed using a suitable adhesive, thereby providing for a frictional and positive-locking connection which is fixed in terms of the creepage path. In this case, the adhesive can serve to avoid a situation in which a creepage path can form over the slot. However, as a result of the recess in the insulation plate, the recess nonetheless is required for this especially simple handling procedure, the longer side edge of the basic insulation module is actually not provided with a barrier extending the creepage path.

However, this is compensated for by the fact that the basic insulation module is angled and as a result a shorter side edge and an opposite longer side edge are formed in each case. The longer side edge accordingly has a longer creepage path than the shorter side edge anyway, and therefore an extension of the creepage path by means of an insulation plate arranged transversely thereto is not absolutely necessary for the longer side edge. Nonetheless, it is expedient to cause the respective slot to also completely encircle the longer side edge of the basic insulation module and to at least extend the creepage path at the longer side edge to a certain degree by this slot region, which is not required mechanically. The completely unused slots also help to likewise improve the insulation.

In the installed state, the basic insulation module can be arranged horizontally at its first end in the transformer tank and angled upwards at its second end. An increased length of the basic insulation module at a predetermined distance between transformer and tank wall is achieved by the angled configuration, which has a positive effect on both the insulating ability and a reduced space requirement.

The individual adaptability of the holder according to the present disclosure makes it possible for a variant which is optimized from the insulation point of view and is therefore very space-saving to be provided for each installation location of a holder, such that ultimately the volume of the oil-filled space within the oil tank or the size of the oil tank can be reduced at the same transformer output.

In accordance with an exemplary embodiment of the present disclosure, a first region having a mainly straight extent is provided in the region of the first end of the basic insulation module, within which first region the adjacent slots are arranged parallel to one another. This linear region proves to be advantageous from the insulation and production point of view and can include, for example, at least five parallel slots, which are arranged at a distance of 1 cm to 1.5 cm, for example, in each case.

In accordance with an exemplary embodiment of the present disclosure, at least one slot angled relative to the slots in the first region is provided in the angled region of the basic insulation module. This arrangement ensures that at least one insulation plate is also arranged approximately transversely to the creepage path along the short side edge in the angled region. This arrangement is especially favorable for an increase in the insulating ability. The same correspondingly applies to further configuration variants, according to which a plurality of slots angled relative to one another are provided in the angled region of the basic insulation module.

In accordance with an exemplary embodiment, the basic insulation module can be arranged within an angular range of 45° to 135°, for example, at a range greater than 90°. As a result of the then curve-like and, in the extreme case, already virtually spiral-like course of the basic insulation module, its angled length is markedly increased in relation to an available width inside the oil tank, as a result of which improved insulating ability is achieved in a space-saving manner. In a similar manner, the insulating ability can also be increased by sections of the basic insulation module being narrowed in width between shorter side edge and longer side edge. Other creepage-path-extending configurations of the two side edges are of course also possible.

In order to ensure especially simple fitting of the holder according to the present disclosure, the connecting device is pluggable, that is to say it can be connected in a positive-locking manner to a corresponding counterpart on the transformer or transformer tank and, if need be, can also be fixed, for example by a retaining bolt. In the simplest case, the connecting device can be embodied as a milled extension of the basic insulation module with, for example, a cylindrical or rectangular cross section.

In accordance with an exemplary embodiment of the present disclosure, the accommodating device has the shape of an inverse or concavely formed circle segment. The radius of this circle segment is oriented mainly according to the radius of the screen tube or that of the barrier system which is to be held by the holder in the installed state. Exemplary radii are between, for example, 5 cm and 12 cm. In the simplest case, the accommodating device can be produced as a milled extension of the basic insulation module. For mechanical reasons, the circle segment can be open at the top in the installed state of the holder, thereby resulting in stable equilibrium of a screen tube supported there.

In accordance with an exemplary embodiment, a belt-like holding device can be provided in the region of the second end, at least on one of the two planar outer sides of the basic insulation module, with which holding device a screen tube can be fixed in the inverse or concave circle segment. In this case, the belt or belt-like band encloses a major part of the circumference of the screen tube and in the process exerts a fixing force in the direction of the circle segment. Accordingly, on its other side, the belt encloses, for example, a shaft-like transverse strut which is connected to the basic insulation module. As a result, the belt is tensioned. A belt-like holding device arranged on both sides of the, for example, 3 cm thick basic insulation module is very simple to produce in terms of construction and reduces any torsional moments on the shaft-like transverse strut, which is then guided by the basic insulation module. In accordance with an exemplary embodiment, the belt can be tensioned by a corresponding device which is adjustable in length. This permits especially simple fitting of a screen tube and its subsequent fixing.

In accordance with an exemplary embodiment of the present disclosure, the holder is produced at least partly from milled pressboard. This concerns, for example, the basic insulation module and the U-shaped insulation plates. According to an exemplary embodiment of the present disclosure, the basic insulation module is plate-like and can therefore also be readily produced from a plate of corresponding thickness, milling being an especially suitable and flexible machining method here. A suitable plate thickness is, for example, 3 cm, in which case the slots can be milled, for example, to a depth of 1 cm. A connection to the insulation plates which is especially favorable from the insulation point of view and mechanically is thereby made possible. The insulation plates can also have a plate-like structure of a few millimeters thickness for ensuring the pluggable connection. Irrespective of the type of processing, pressboard per se is a proven insulation material for use in oil-filled components; but of course other insulation materials are also conceivable.

The advantages according to the disclosure of a holder according to the disclosure also have an effect, in the installed state, on an oil transformer including an oil tank and a high-voltage end lead arranged therein and having a screen tube. This is because the oil tank can then be advantageously designed to be smaller on account of the smaller space requirement, as already explained above.

Further advantageous possible configurations are explained in more detail below with reference to exemplary embodiments illustrated in the drawings.

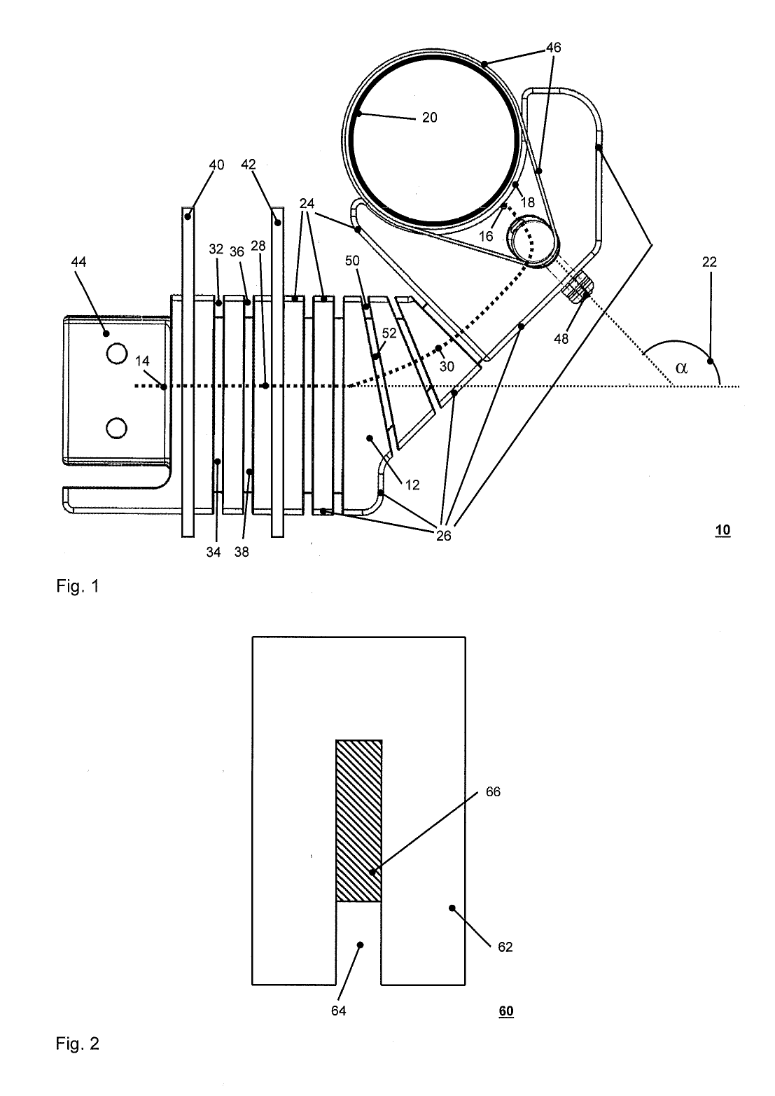

FIG. 1 shows an exemplary side view 10 of a holder with a screen tube in accordance with an exemplary embodiment of the present disclosure. The core element of the holder is a basic insulation module 12 which extends from its first end 14 to the second end 16 along a straight region 28 and an adjoining angled or curved region 30. The total bending angle along the broken line 28, 30 indicating the elongated course amounts to about 130°, as indicated by the reference numeral 22. It can easily be seen how the length of the basic insulation module 12 and thus also the insulating ability thereof are considerably increased by the curved region 30 without this leading to a significantly greater space requirement. In accordance with the bend, a shorter side edge 24 and a longer side edge 26 are obtained, where the longer side edge 26 accordingly has a longer creepage path.

The basic insulation module 12 is produced from a pressboard of a few centimeters thickness, wherein a plurality of completely encircling slots are provided mainly transversely to the elongated extent 28, 30, three of which slots are provided, by way of example, with the reference numerals 32+34, 36+38, 50+52. These slots alone already lead to an improved insulating ability of the basic insulation module 12. For further improvement in the insulating ability of the holder 10, for example, in the region of the shorter side edge 24, two U-shaped insulation plates 40, 42 are pushed into two of the encircling slots from the shorter side edge 24 and are adhesively bonded therein.

A connecting device 44, which may be embodied as a plug-in connection, for example, is provided at the first end 14 of the basic insulation module 12 as the extension thereof. A concave circle segment 18 is milled in the second end 16 of the basic insulation module 12, likewise as the extension thereof, where the circle segment 18 has approximately the same diameter as a tube 20 held by it. The tube 20 is enclosed by a belt-like device 46, is pressed into the concave circle segment 18 and is thus securely fixed. In addition, the belt-like device 46 encloses, in a loop-like manner, a shaft-like tensioning device 48 which can be adjusted in length using an adjusting screw, for example, and therefore determines the applied pressure of the belt-like device 46.

FIG. 2 shows a third U-shaped insulation plate 62 on a basic insulation module in a view 60 according to an exemplary embodiment of the present disclosure. In order to be able to push the actually rectangular shape of the insulation plate 62, which has, for example, a surface area of 20 cm by 35 cm, into a slot provided in the basic insulation module, a recess 64 is provided, the open end of which lies in the region of the longer side edge of the basic insulation module, which in this case is indicated with a cross section having the reference numeral 66. All the slots of the basic insulation module can be formed in such a way that an insulation plate 62 can be pushed into each encircling slot and be adhesively bonded therein.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE NUMERALS

10 Exemplary side view of a holder with screen tube
12 Basic insulation module
14 First end of the basic insulation module
16 Second end of the basic insulation module
18 Accommodating device in the form of an inverse circle segment
20 Screen tube
22 Angle
24 Shorter side edge
26 Longer side edge
28 Elongated extent in the straight region
30 Elongated extent in the angled region
32 First slot in the shorter side edge
34 First slot in the first planar outer side
36 Second slot in the shorter side edge
38 Second slot in the first planar outer side
40 First U-shaped insulation plate
42 Second U-shaped insulation plate
44 Connecting device
46 Belt-like holding device
48 Tensioning device
50 Third slot in the shorter side edge in the angled region
52 Third slot in the first planar outer side in the angled region
60 Third U-shaped insulation plate on the basic insulation module
62 Third U-shaped insulation plate
64 Recess
66 Cross section of the basic insulation module

What is claimed is:

1. A holder for high-voltage end leads in oil transformers, the holder comprising:
a plate-like, elongated basic insulation module which has two planar outer sides, a first end and a second end, wherein:
the basic insulation module includes a connecting device at the first end and an accommodating device for a transversely running screen tube in a region of the second end;
the basic insulation module is angled between the first end and the second end, such that a shorter side edge and an opposite longer side edge are formed;
the basic insulation module includes a plurality of adjacent slots provided transversely to an elongated extent of the basic insulation module, the slots encircling the basic insulation module at its planar outer sides and at the shorter side edge in a respective plane; and
the basic insulation module includes at least one U-shaped insulation plate fitted into one of the slots in a positive-locking manner.

2. The holder according to claim 1, wherein a first region having a mainly straight extent is provided in the region of the first end of the basic insulation module, within which first region the adjacent slots are arranged parallel to one another.

3. The holder according to claim 2, wherein at least one slot angled relative to the slots in the first region is comprised in the angled region of the basic insulation module.

4. The holder according to claim 3, wherein a plurality of slots angled relative to one another are comprised in the angled region of the basic insulation module.

5. The holder according to claim 1, wherein the basic insulation module is arranged within an angular range of 45° to 135°.

6. The holder according to claim 1, wherein the basic insulation module is narrowed in its width between the shorter side edge and the longer side edge, at least in sections, towards the second end.

7. The holder according to claim 1, wherein the connecting device is pluggable.

8. The holder according to claim 1, wherein the accommodating device has the shape of an inverse circle segment.

9. The holder according to claim 8, comprising:
a belt-like holding device provided in the region of the second end, at least on one of the two planar outer sides of the basic insulation module,
wherein the holding device is configured to fix a screen tube in the inverse circle segment.

10. The holder according to claim 9, wherein the at least one belt-like holding device is configured to be tensioned.

11. The holder according to claim 1, wherein the holder is formed at least partly from milled pressboard.

12. An oil transformer comprising:
an oil tank; and
a high-voltage end lead arranged in the oil tank and having a screen tube,
wherein the screen tube is held, at least in sections, by at least one holder according to claim 1.

13. The holder according to claim 3, wherein the basic insulation module is arranged within an angular range of 45° to 135°.

14. The holder according to claim 3, wherein the basic insulation module is narrowed in its width between the shorter side edge and the longer side edge, at least in sections, towards the second end.

15. The holder according to claim 3, wherein the connecting device is pluggable.

16. The holder according to claim 3, wherein the accommodating device has the shape of an inverse circle segment.

17. The holder according to claim 16, comprising:
a belt-like holding device provided in the region of the second end, at least on one of the two planar outer sides of the basic insulation module,
wherein the holding device is configured to fix a screen tube in the inverse circle segment.

18. The holder according to claim 17, wherein the at least one belt-like holding device is configured to be tensioned.

19. The holder according to claim 3, wherein the holder is formed at least partly from milled pressboard.

20. An oil transformer comprising:
an oil tank; and
a high-voltage end lead arranged in the oil tank and having a screen tube,
wherein the screen tube is held, at least in sections, by at least one holder according to claim 19.
